(19) United States
(12) Patent Application Publication
(10) Pub. No.: US 2020/0288641 A1
(43) Pub. Date: Sep. 17, 2020

(54) LIGHT REFLECTION APARATUS FOR PLANTS

(71) Applicant: LESLIE DAVID HOWE, OTTAWA (CA)

(72) Inventor: LESLIE DAVID HOWE, OTTAWA (CA)

(73) Assignee: SOUTHPAC TRUST INTERNATIONAL INC., TRUSTEE OF THE LDH TRUST, RAROTONGA (CK)

(21) Appl. No.: 16/811,578

(22) Filed: Mar. 6, 2020

Related U.S. Application Data
(60) Provisional application No. 62/817,728, filed on Mar. 13, 2019.
(60) Provisional application No. 62/884,035, filed on Aug. 7, 2019.

(51) Int. Cl. A01G 7/04; G02B 5/08; G02B 7/182; F21V 7/05; F21V 7/00; F21V 7/16

(52) U.S. Cl. CPC A01G 7/045; G02B 5/0816; F21V 7/16; F21V 7/05; F21V 7/0016; G02B 7/182

(57) ABSTRACT

In an example embodiment, a plant light reflection apparatus may comprise two opposing reflector panels configured to reflect light, wherein each reflector panel may comprise one or more pieces of reflection material. A reflector support apparatus may be configured to support the at least two opposing reflector panels, and may comprise a central section configured to accept one or more plants. The bottom major edges of the one or more pieces of reflection material of the two opposing reflector panels may be disposed in proximity to main stems of the one or more plants in the central section, and to reflect light thereon.

### CROSS REFERENCE TO RELATED APPLICATIONS

This application claims the benefit of U.S. Provisional Patent Application No. 62/817,728 filed Mar. 13, 2019 entitled “LIGHTING AND REFLECTION SYSTEMS FOR PLANTS”, the contents of which are incorporated by reference in their entirety as if set forth in full.

This application claims the benefit of U.S. Provisional Patent Application No. 62/884,035 filed Aug. 7, 2019 entitled “LIGHT REFLECTION APPARATUSES FOR PLANTS”, the contents of which are incorporated by reference in their entirety as if set forth in full.

### TECHNICAL FIELD

This disclosure generally relates to light reflectors and apparatuses for plants.

### BACKGROUND

There is a continuing need for horticulture systems that can save energy and increase yields.

### BRIEF DESCRIPTION OF THE FIGURES

FIG. 1A shows a perspective view of an example embodiment of a light reflection apparatus for plants with a stem retention hole.

FIG. 1B shows a perspective view of the example embodiment of a light reflection apparatus for plants shown in FIG. 1A, and engaged with a plant and disposed on a trellis net.

FIG. 2A shows a perspective view of several adjacent example embodiments of a light reflection apparatus for plants shown in FIG. 1B.

FIG. 2B shows a perspective view of the example embodiment of a light reflection apparatus for plants as shown in FIG. 1A, but with a gripper hole instead of a stem retention hole.

FIG. 3A shows a side view another example embodiment of a light reflection apparatus for plants.

FIG. 3B shows a perspective view of the example embodiment of a light reflection apparatus for plants shown in FIG. 3A

FIG. 3C shows a perspective view of two of the example embodiments of a light reflection apparatuses for plants shown in FIG. 3A, wherein two opposing apparatuses form a single reflector unit.

FIG. 4A shows a side view close up of the attachment of the reflector panel and reflector support apparatus attachment devices to an upper frame member of the example embodiment of a light reflection apparatus for plants shown in FIG. 3A.

FIG. 4B shows a side cut-away view of the example embodiment of a light reflection apparatus for plants shown in FIG. 3A and highlights reflector support apparatus attachment devices.

FIG. 5A shows a perspective view of an example embodiment of a light reflection apparatus for plants comprising a stand.

FIG. 5B shows a side view of the example embodiment of a light reflection apparatus for plants comprising a stand as shown in FIG. 5A.

FIG. 6 shows a perspective view of an example embodiment of a light reflection apparatus for plants comprising a stand as shown in FIG. 5A and further comprising plants therein.

FIG. 7A shows a perspective view of another example embodiment of a light reflection apparatus for plants.

FIG. 7B shows a side view of the example embodiment of a light reflection apparatus for plants shown in FIG. 7A.

FIG. 8A shows a perspective view of the reflector support apparatus shown in FIG. 7A

FIG. 8B shows a top view of the reflector support apparatus shown in FIG. 7A

FIG. 8C shows a side profile view of the reflector support apparatus shown in FIG. 7A

FIG. 9 shows a side profile view of the light reflection apparatus shown in FIG. 7A with plants, and the reflector panels nested in reflector nesting channels configured in the reflector support apparatus.

### DETAILED DESCRIPTION

Indoor horticulture such as growing plants in greenhouses and buildings etc. have become prominent growing methods for a variety of plants. Indoor growing may be advantageous; for example the growing conditions such as temperature, humidity, lighting cycles and pest control may be optimally controlled. Cannabis is one such crop that may benefit from indoor growing, and in fact, the practice has become widespread. Although various embodiments of the invention may be described with respect to cultivating cannabis, this is for illustrative purposes only, and should not be construed to limit the scope of possible applications for the various embodiments of the disclosed invention. The written descriptions may use examples to disclose certain implementations of the disclosed technology, including the best mode, and may also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The words “stem” or “shoot” may be used interchangeably. Certain example embodiments of plant reflectors herein described may fit on any suitable appendage of a plant, and the use of the words “stem” or “shoot” should not be construed to limit the generality thereof.

The words “reflector panel” and “reflector material” and “reflector material piece(s)” may be used interchangeably in certain instances in the specification.

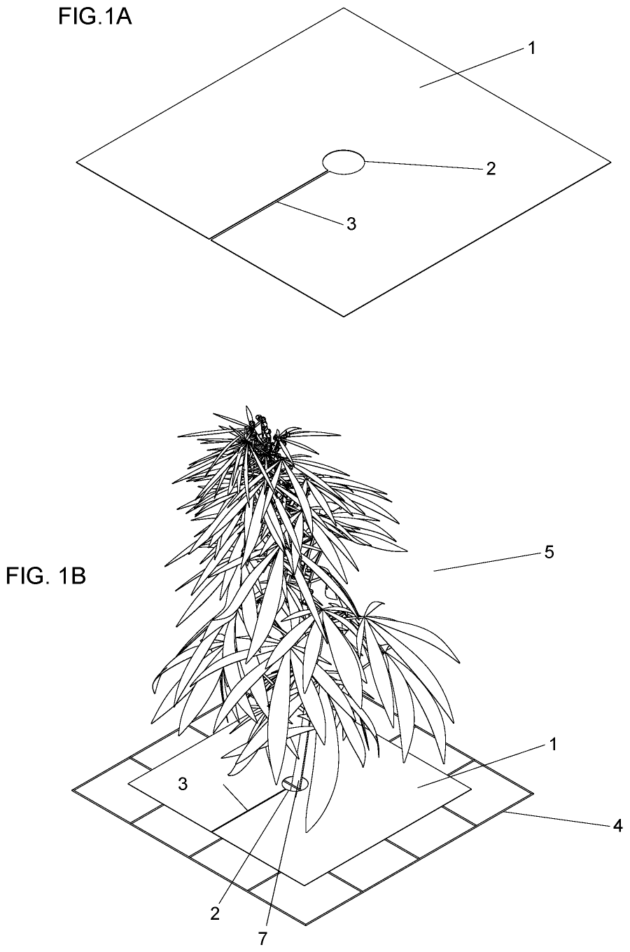

An example of a light reflection apparatus for plants is shown in FIGS. 1A and 1B. Referring to FIG. 1A, plant reflector panel 1 may be fabricated from and any reflective film, but preferably reflection films (or variations thereof) described in related applications. It may be preferable if the reflection film had very high reflective efficiency, perhaps over 97% for example, very high diffuse Lambertian type reflection over 97%, was UV stable, and was relatively impervious to water or humidity.

In an example embodiment, the installation slot 3 and stem retaining hole 2 may be cut into the reflector panel 1 using any effective means such as steel rule die cutting or flatbed cutting machines for example. Referring to FIG. 1B, the reflection panel 1 may be installed on a plant by sliding the plant stem 7 from plant 5 through the installation slot 3 until the plant stem 7 may be disposed within the stem retaining hole 2. The reflector panel 1 may be supported by a trellis net 4. Trellis nets are commonly used in cannabis cultivation, and may typically be supported by poles attached to grow tables or inserted into the ground, plant pots etc.

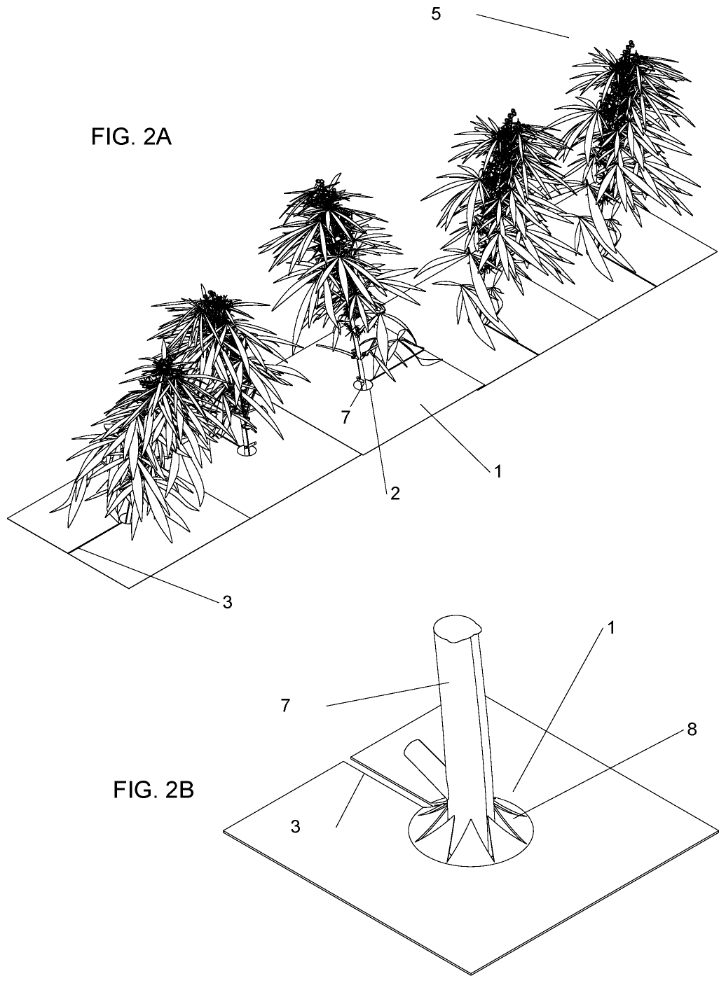

In an example embodiment, the reflector panel 1 dimensions may be fabricated using any suitable dimension for a particular application. It may be preferable to configure the reflector panel 1 dimensions by using a distance less than the desired spacing between adjacent plant stems 7 (FIG. 2A), wherein adjacent reflector panels may overlap each other. Referring to FIG. 2A, adjacent plants 5 with installed reflector panels 1 of appropriate sizes are shown, that together may create a row of reflector panels which may overlap. In an example embodiment, it may be preferable to have overlapping reflector panels to avoid any gaps which may result in lost light. In an example embodiment, it may be preferable for reflector panels to cover an entire trellis net in order to maximum light recycling.

In an example embodiment as shown in FIG. 2B, the reflector panel 1 may attach to a plant stem 7 using a stem gripper hole 8 which may be fabricated using a star cutout method in the reflector panel 1 for example. Any other suitable attachment method may also be utilized, such as clips or fasteners for example. Using a diameter which may be slightly larger than the proposed stem diameter, a temporary circle may be drawn wherein cuts are made through the reflection material across the diameter of the temporary circle. The cuts may be angled at 90 degrees or 45 degrees from each other, or any angle which may be suitable for a given application. Once the plant stem is pushed into the stem gripper hole 8, the V-shaped sections of reflector material of the stem gripper hole 8 may protrude around the plant stem 7 as shown in FIG. 2B (not to scale) and therein secure the reflector panel 1 to the plant stem 7.

The examples of a light reflection apparatuses for plants as shown in FIGS. 1A and 1B and 2A and 2B may have benefits which may function to lower lighting energy costs and increase yields. Typically with overhead lighting, whether sunlight or light fixtures, any incident light rays that do not strike the plant may not get reflected back at the plant, and may be lost. This may be mitigated to a small degree if the grow room has reflective surfaces such as white painted floors and walls. Painted walls may only help in recycling some light back to plants that are in close proximity to the walls, but in larger rooms, there may only be a very small percentage of wall surface area relative to the grow area. Painted floors may help to a larger degree, but the reflective efficiency of white paint may only be about 85%, and due to the inverse square law of light, the large distance from the floor to the plant canopy may cause the amount of reflected light to be negligible.

In example embodiments as described, very high efficiency reflection panels can surround the plant canopies, overlap, and thus form a large reflector, the size of which may only be limited to the size of the plant rows. Due to the high reflection efficiency of the reflector panel and the close proximity to the plant canopies, a significant amount of light can be captured and recycled to the plants that would otherwise be lost. Additionally, the Lambertian reflection distribution pattern of the reflection panel may cause incident light rays to reflect relatively homogeneous luminance when viewed from all directions emanating in the half-space adjacent to the surface. This may be very advantageous considering the tower/cone shape of cannabis colas, wherein incident light to the reflector may reflect and strike the sides of the cola, and not merely be reflected predominantly straight up and lost as may occur with a specular reflection surface.

With plant cultivation, and in particular commercial cannabis cultivation, yields may be highly correlated to light levels. More light can mean higher yields. Given the high monetary value of crops such as cannabis, a significant increase in light received by the plants due to example embodiments of light reflection apparatuses for plants may mean a very large increase in revenue.

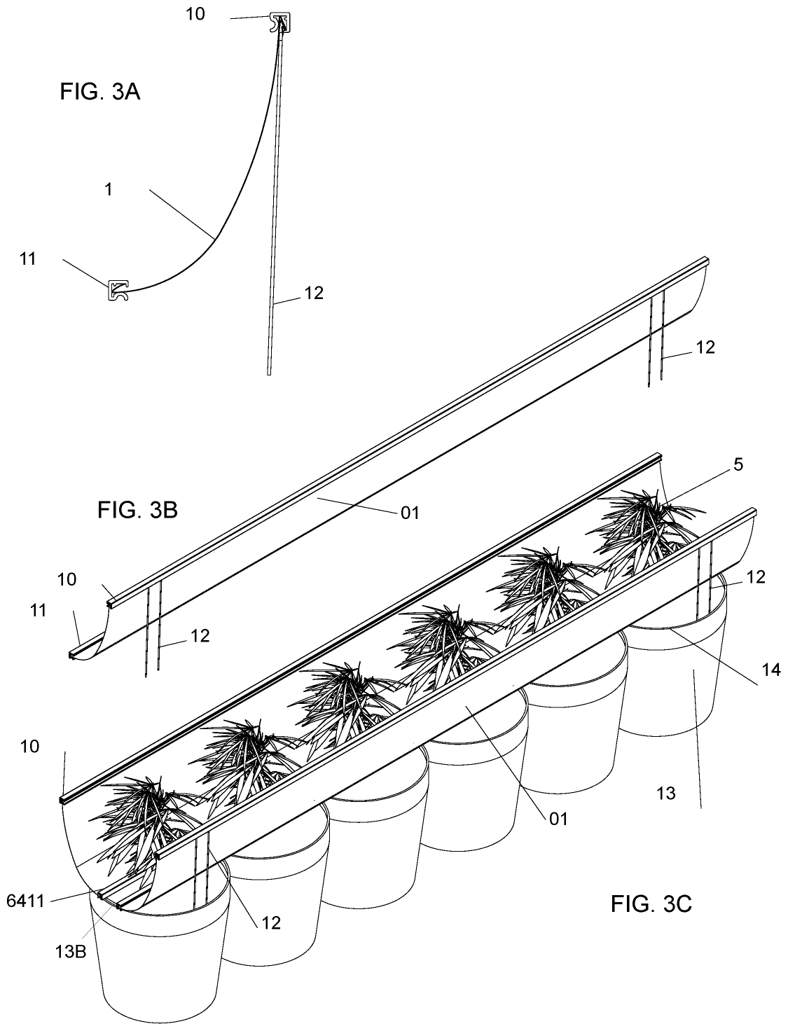

Another example embodiment of light reflection apparatuses for plants is shown in FIGS. 3A, 3B and 3C. Said embodiment may be suitable for use with rows of pots with smaller plants, such as in a vegetation or clone rooms for cannabis.

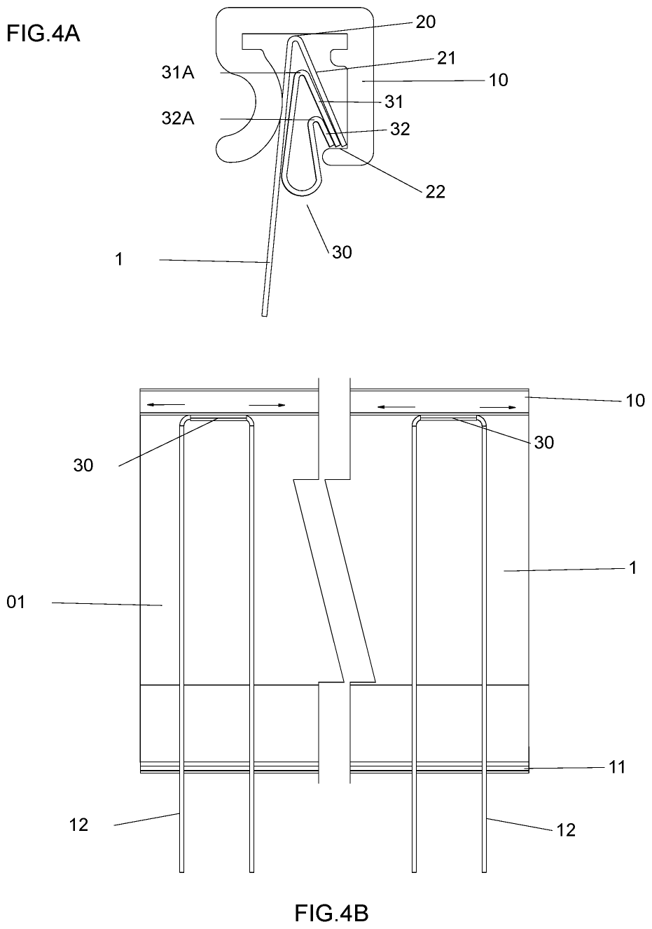

Referring to FIGS. 3A, 3B and 3C in an example embodiment, reflector panel 1 may be attached to a top frame piece 10 and a bottom frame piece 11. Both the frame pieces 10 and 11 may attach to the reflector panel 1 in a manner similar to that shown in FIG. 4A. The reflector panel 1 may be configured with edge trusses 21 configured from folds 20 along each of the long edges of the panels 1, wherein the edges of the edge trusses formed on reflector panel 1 engage with the edge truss retention feature 22 of the frame pieces 10 and 11. Any other suitable or practical frame pieces and methods of attachment of the reflector panel to the frame pieces may also be utilized. In an example embodiment for example, the reflector piece may be attached to the frame pieces using methods such as gluing, stapling, crimping, fasteners such as rivets, screws, pins etc. In an example embodiment the bottom frame piece may be omitted.

In an example embodiment, the bottom frame piece 11, after the plant reflector assembly is configured with plants, may be disposed on top of plant containment devices 13, resting on the rims 13B thereof, and either touching or in close proximity to the stems 7 of plants. The plant reflector assembly may also be disposed on top of plant growing medium of one or more plants after be configured with plants. The top frame piece 10 may be supported at each end at a predetermined height above the bottom frame piece 11 with reflector support apparatuses, which may comprise any suitable support device, but may include U-shaped stakes 12 which may be attached to the top frame piece 10 and also inserted into the soil in pots 13. Through the placement of stakes 12, both with the depth the stakes 12 are inserted into the soil, as well as the lateral distance they are positioned from the bottom frame piece 11, an optimum curve can be formed on the reflector panel 1, therein maximizing the amount of light which may be reflected towards the plants 5. Other methods of reflector support apparatuses may also be utilized, and the reflector support apparatuses described should not be construed to limit the generality thereof. In example embodiments for example, reflector support apparatuses may attach to plant containment devices directly

In an example embodiment, another novel feature of the of light reflection apparatus for plants is shown in FIGS. 4A and 4B. Reflector support apparatus attachment devices 30 are shown. Reflector support apparatuses 12 may nest in reflector support apparatus attachment devices 30, wherein the reflector support apparatus attachment devices 30 may be slid along the top frame member 10 (as shown by the arrows in FIG. 4B) thereby adjusting the positioning of the stakes to allow for different spacing requirements.

Referring to FIG. 4A, in an example embodiment, reflector support apparatus attachment device 30 may be fabricated using a sturdy plastic film. Although any material may be used that may allow edge trusses to be formed, plastic film such as 250 um thick PET film may be preferable for the sake of robustness. Edge truss 31 may be configured along fold 31A, and edge truss 32 may be formed along fold 32A. After the reflector panel 1 is attached, wherein edge truss 21 is configured along fold 20 and is nested against edge truss retention feature 21 of upper frame piece 10, then edge truss 31 of the reflector support apparatus attachment device 30 may be inserted and subsequently nest against the edge truss retention feature 21 of upper frame piece 10. The upper horizontal portion of the reflector support apparatus 12 can be positioned on the reflector support apparatus attachment device 30, and then edge truss 32 of the reflector support apparatus attachment device 30 may be looped around the upper horizontal portion of the reflector support apparatus 12 and subsequently inserted into the upper frame piece 10, wherein the edge truss 32 may engage the edge truss retention feature 21 of upper frame piece 10.

The advantages of the light reflection apparatuses for plants as shown in FIGS. 4A and 4B are similar to advantages previously described. However, due to the smaller plants with less foliage as well as the semi parabolic configuration of the reflector, the quantity of light reflected may be significantly higher.

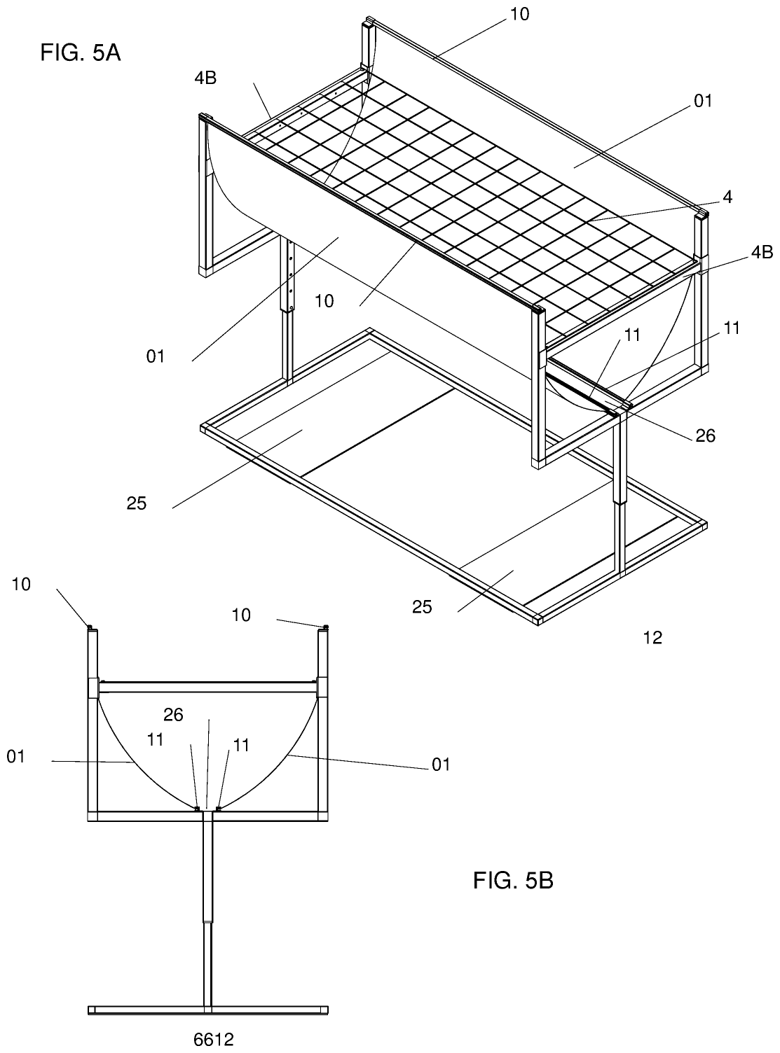

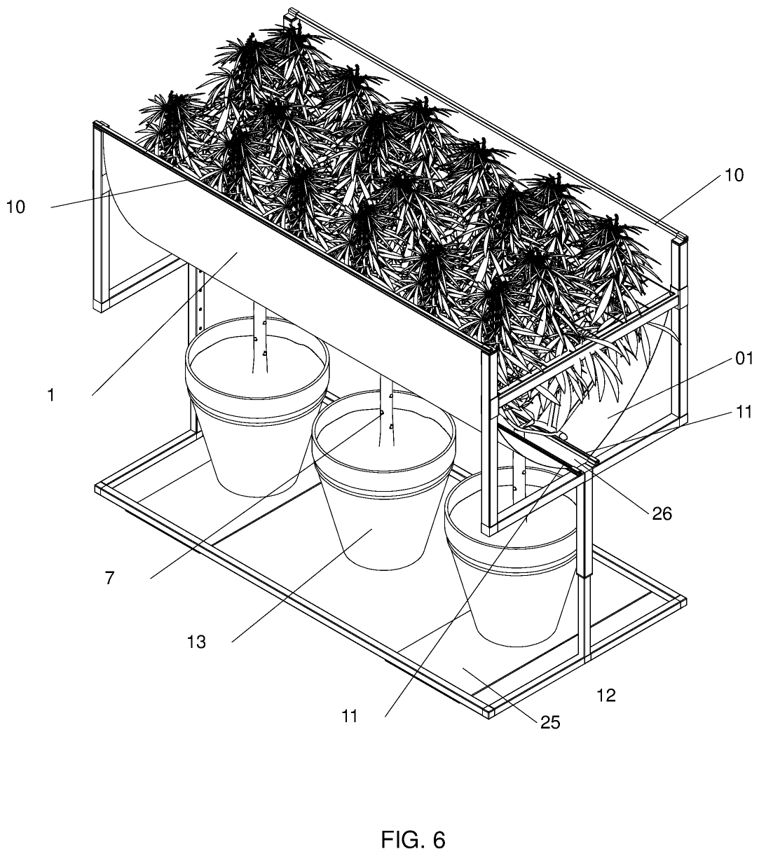

Another example embodiment of light reflection apparatuses for plants is shown in FIGS. 5A, 5B and 6. The basic principles may be the same as the example embodiment shown in FIGS. 3A, 3B, 3C, 4A and 4B, except the reflector support apparatus as previously described may be substituted for a reflector support stand 12 (FIGS. 5A and 5B) and 12 (FIG. 6). This may allow the use of larger reflectors on taller plants. Alternate stand configurations may also be utilized.

Referring to FIGS. 5A and 5B in an example embodiment, upper frame member 10 and lower frame member 11 with reflector panel 1 may be fabricated as previously described. Optional trellis netting 4 may be attached to trellis crossbars 4B by any suitable means. The two lower frame members 11 may form a stem slot 26, wherein plant stems, shoots, trunks etc. may protrude through, allowing plant foliage to be disposed inside the two reflectors 1. Plant containment devices may be placed on stand base plates 25 in order to help prevent the stand 12 from moving.

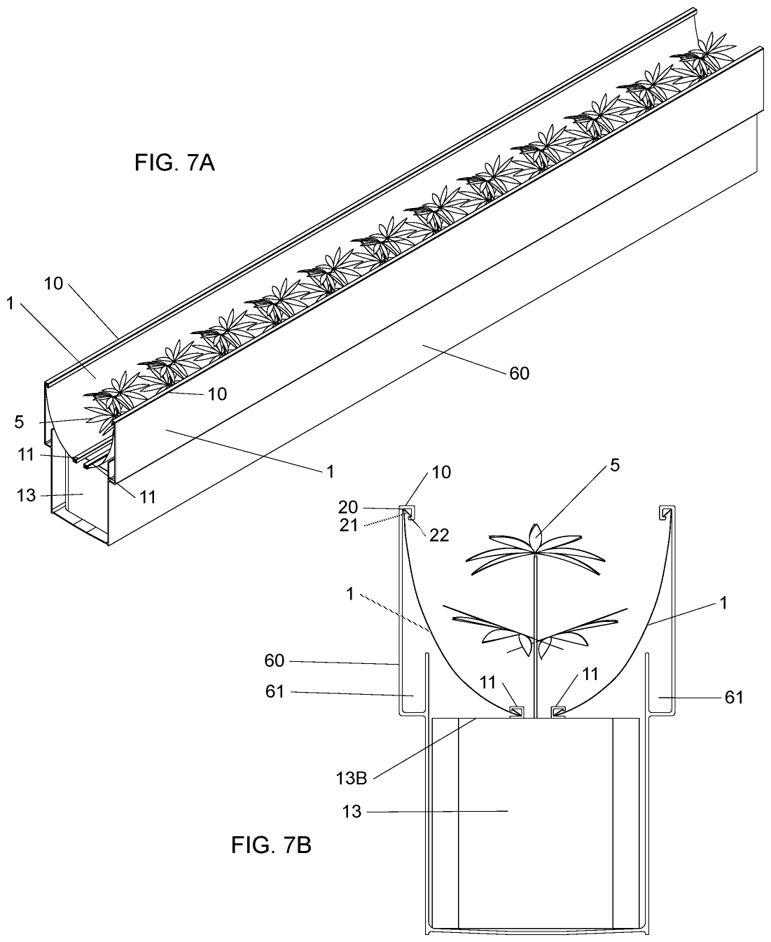

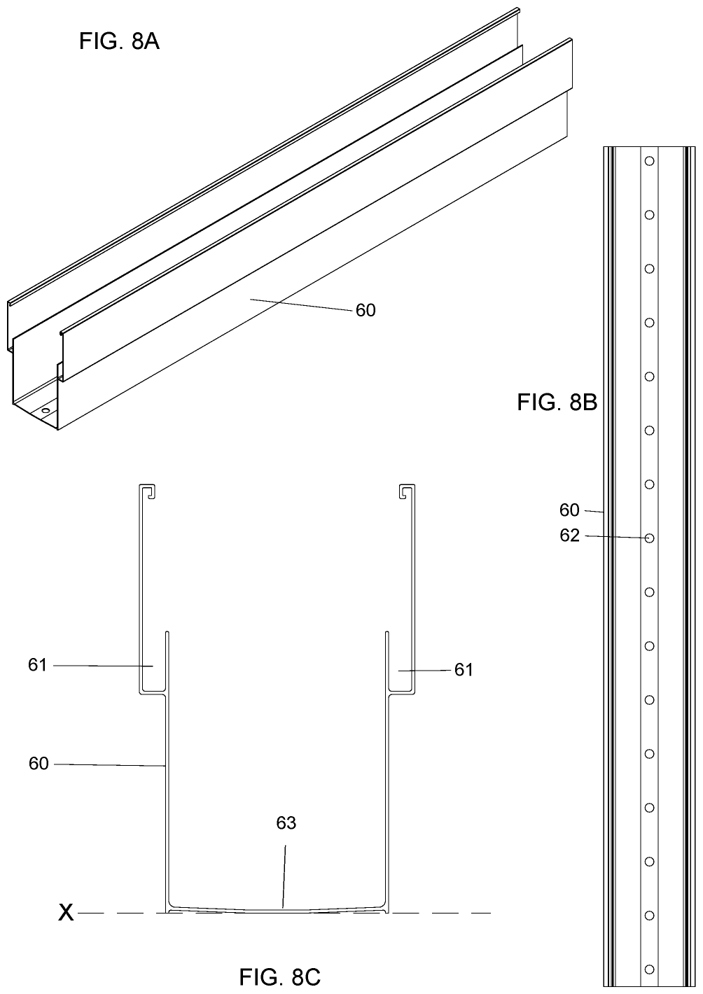

An example embodiment of plant reflector similar to that shown in FIG. 3C is shown in FIG. 7 through FIG. 9. The basic functionality may be similar or the same as previously discussed with reference to other example embodiments, and for brevity may not necessarily be repeated. Referring to FIGS. 8A, 8B and 8C in an example embodiment, a reflector support structure 60 may employed. In an example embodiment, the reflector support structure 60 may comprise a single extruded plastic or metal profile, or in other example embodiments may comprise two or more extruded individual sections that may subsequently be attached together. Any other suitable means of fabrication may also be utilized, such as vacuum forming, stamping etc. The reflector support structure 60 may comprise a reflector nesting slot 61 and drainage holes 62. The bottom of the reflector support structure 60 may comprise a sloped or curved bottom 63 relative to the horizontal plane X, which may allow water or other liquids to flow towards the drainage holes 62.

Referring FIGS. 7A and 7B in an example embodiment, plants 5 comprising plant containment devices 13 which may further comprise plant containment device rims 13B, may be disposed inside the reflector support structure 60 as shown. The top frame piece 10 may be integral to the reflector support structure and may comprise edge truss retention feature 22, thus eliminating the need for a separate frame piece. The reflector 1 may comprise folds 20 and edge trusses 21 on both major edges as previously discussed, and may attached to the integral top frame piece 10 and bottom frame member 11 as previously discussed.

In an example embodiment, the lower frame member 11 (FIG. 7A for example) may be eliminated. The major edge of the reflector 1 that may have attached to the eliminated frame member 11 may be configured with a fold which thereby may avoid a reflector edge cutting a plant stem, or may also be configured as simply a straight edge if suitable for a given application. Any similar example embodiments of plant reflection apparatuses previously shown or discussed may also be configured in a similar manner.

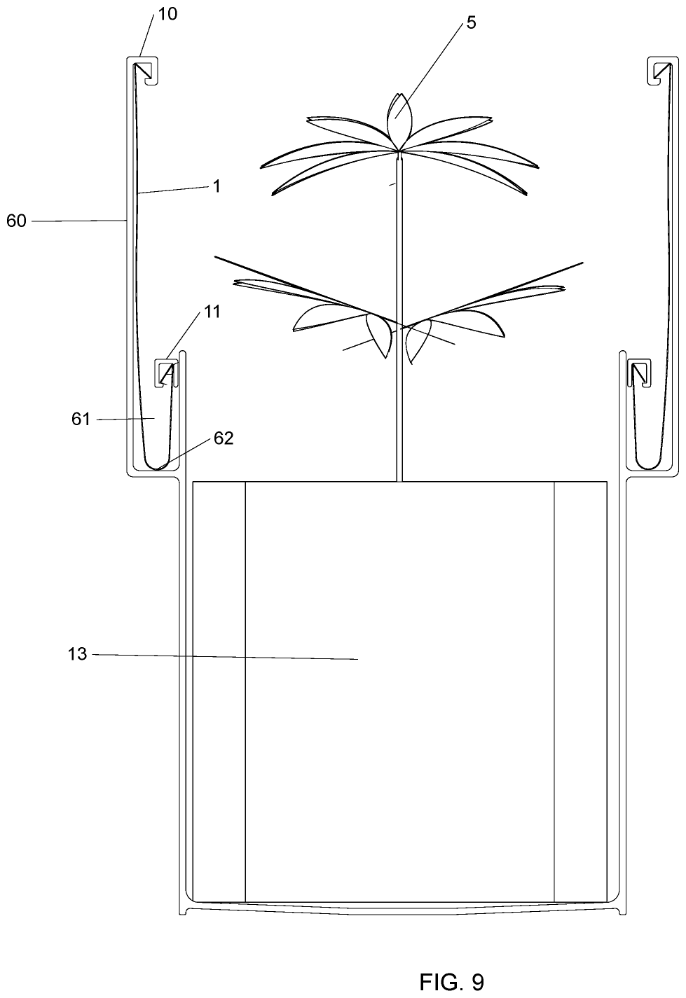

Referring to FIG. 9 in an example embodiment, a profile view is shown wherein the light reflection apparatus is shown with the reflector 1 and bottom frame member 11 nested in the reflector nesting channel 61. When nested, a loose fold or kink 62 may form in the reflection material, thereby allowing the reflector 1 and frame member 11 to nest in the reflector nesting channel 61. This may also be a novel advantage wherein during plant maintenance procedures or during the insertion or removal of plants from the apparatus, the reflector 1 and bottom frame member will not cause interference.

In an example embodiment of the disclosed technology, a plant light reflector may comprise a reflector panel configured to reflect light. The reflector panel may comprise reflection material, an installation slot, and a stem retention hole or a stem gripper hole. The reflector panel may be configured to attach to, or surround a stem or shoot of a plant, and reflect light back towards the portion of the plant disposed above the reflector panel.

In an example embodiment, the reflector panel may be configured to lay on trellis netting.

In an example embodiment, the reflector panel may be configured to be supported only by a plant through its attachment to a stem or shoot of the plant.

In an example embodiment, the gripper hole may be configured from star shaped cuts in the reflector panel, which whereby may form V-shaped protuberances when a stem or shoot is inserted into the gripper hole, and thereby attaching the reflector panel to the shoot or stem.

In an example embodiment, multiple adjacent reflector panels may be configured to overlap and form a larger continuous reflector.

In an example embodiment of the disclosed technology, a plant light reflector may comprise a reflector panel configured to reflect light. The reflector panel may comprise an upper frame member, a piece of reflection material, an optional lower frame member, and one or more reflector support apparatuses attached to at least the upper frame member. After installation, the optional bottom frame member may be configured to lay on one or more plant pot rims in proximity to stems or shoots of plants contained therein, and the upper frame member may be supported by the one or more reflector support apparatuses inserted into soil of the one or more plant pots.

In an example embodiment, the reflector panel may further comprise at least an upper frame member which may further comprises four sides, and further comprise a channel comprising a first surface, a second surface that opposes the first surface, and an edge truss retention feature. The reflection material may comprise at least two long edges and a first surface, wherein at least one of the long edges may be configured with at least one edge truss, wherein the at least one edge truss may be configured from a corresponding fold in the reflection material that extends along all, or a portion of a corresponding long edge of the reflection material. The at least one edge truss may be configured at an angle relative to the first surface of the reflection material, and wherein the outermost edge of the at least one edge truss may comprise an outer perimeter edge. The reflection material may be configured for attachment to the at least an upper frame member such that the at least one edge truss of the reflection material may nest inside a corresponding channel of the at least an upper frame member. The perimeter edge of the at least one edge truss may be engaged by the corresponding channel's edge truss retention feature such that the at least one edge truss may become lodged and secured within a corresponding at least an upper frame member.

In an example embodiment, the reflector support apparatuses may be U-shaped wire garden stakes.

In an example embodiment, the reflector support apparatuses may be attached to the upper frame member with reflector support apparatus attachment devices.

In an example embodiment, the reflector support apparatus attachment devices may be configured to attach the U-shaped garden stakes to the upper frame member, wherein the reflector support apparatus attachment devices may be slid along the upper frame member.

In an example embodiment, the reflector support apparatus attachment devices may be configured with two edge trusses configured to attach to the upper frame member.

In an example embodiment, the plant light reflector may comprise two plant light reflectors, wherein the light reflecting sides of the two reflector panels are facing each other, and wherein the profile thereof forms a relative U-shape.

In an example embodiment of the disclosed technology, a plant light reflection apparatus may comprise at least two opposing reflector panels configured to reflect light, wherein each reflector panel may comprise one or more pieces of reflection material, and wherein each piece of reflection material may comprise a top major edge and a bottom major edge. A reflector support apparatus may comprise a central section comprising a base and at least two opposing top sections, wherein the central section may be configured to accept one or more plants. The reflector support apparatus may be configured to support the at least two opposing reflector panels such that the reflector panels are partially suspended adjacent to one or more plants that are accepted by the central section. After the acceptance of one or more plants into the central section, the bottom major edges of the one or more pieces of reflection material of the at least two opposing reflector panels may be disposed in proximity to main stems of the one or more plants in the central section, and may be configured to reflect light on the one or more plants disposed in the central section.

In an example embodiment, the plant light reflection apparatus may comprise one or more pieces of reflection material which may further comprise reflective optical film.

In an example embodiment, the plant light reflection apparatus may comprise one or more pieces of reflection material which may further comprise reflective optical film, and wherein the one or more pieces of reflection material may form opposing reflective surfaces configured to reflect light towards plants accepted in the central section of the reflector support apparatus.

In an example embodiment, the reflector support apparatus may comprise channels configured in the at least two opposing top sections which may be configured to engage and attach folds configured in the reflection material. The one or more pieces of reflection material may comprise reflective optical film with folds configured along the top major edge of each piece of reflection material. The folds may be configured to engage and attach to the channels of the at least two opposing top sections of the reflector support apparatus.

In an example embodiment, the bottom major edge of the each piece of reflection material may be attached to a linear frame member, and wherein the linear frame member may be configured to lay on the surface of one or more plant growing mediums, or the uppermost edge of one or more plant containment devices of plants accepted by the central section.

In an example embodiment, the bottom major edge of the each piece of reflection material may comprise a fold, and wherein the fold may be configured to lay on the surface of one or more plant growing mediums, or the uppermost edge of one or more plant containment devices of plants accepted by the central section.

In an example embodiment, the reflector support apparatus may further comprise opposing reflector nesting channels disposed between the at least two opposing top sections and the base of the central section of the reflector support apparatus. The at least two opposing reflector panels may further comprise flexible reflection material, and may be configured to fully or partially nest inside the opposing reflector nesting channels.

In an example embodiment, the reflector support apparatus may be a one piece extruded profile.

In an example embodiment, the plant light reflection apparatus may comprise liquid drainage holes in the base of the central section of the reflector support apparatus.

I claim:

1. A plant light reflector comprising:
a reflector panel configured to reflect light, the reflector panel comprising:
reflection material;
an installation slot; and
a stem retention hole or a stem gripper hole;
wherein the reflector panel is configured to attach to, or surround a stem or shoot of a plant, and reflect light back towards the portion of the plant disposed above the reflector panel.

2. The reflector panel of claim 1, wherein the reflector panel is configured to be supported only by a plant through its attachment to a stem or shoot of the plant.

3. The reflector panel of claim 1, wherein the gripper hole is configured from star shaped cuts in the reflector panel, thereby forming V-shaped protuberances when a stem or shoot is inserted into the gripper hole, and thereby attaching the reflector panel to the shoot or stem.

4. The reflector panel of claim 1, wherein multiple adjacent reflector panels are configured to overlap and form a larger continuous reflector.

5. A plant light reflection apparatus comprising:
at least two opposing reflector panels configured to reflect light, wherein each reflector panel comprises one or more pieces of reflection material, and wherein each piece of reflection material comprises a top major edge and a bottom major edge;
a reflector support apparatus comprising a central section comprising a base, and at least two opposing top sections, wherein the central section is configured to accept one or more plants, and wherein the reflector support apparatus is configured to support the at least two opposing reflector panels such that the reflector panels are partially suspended adjacent to one or more plants that are accepted by the central section;
wherein after the acceptance of one or more plants into the central section, the bottom major edges of the one or more pieces of reflection material of the at least two opposing reflector panels are disposed in proximity to main stems of the one or more plants in the central section, and configured to reflect light on the one or more plants disposed in the central section.

6. The plant light reflection apparatus of claim 6, wherein the one or more pieces of reflection material comprise reflective optical film.

7. The plant light reflection apparatus of claim 6, wherein the one or more pieces of reflection material comprise reflective optical film, and wherein the one or more pieces of reflection material form opposing reflective surfaces configured to reflect light towards plants accepted in the central section of the reflector support apparatus.

8. The plant light reflection apparatus of claim 6, wherein the reflector support apparatus comprises channels configured in the at least two opposing top sections which are configured to engage and attach folds configured in the reflection material, and wherein the one or more pieces of reflection material comprise reflective optical film with folds configured along the top major edge of each piece of reflection material, wherein the folds are configured to engage and attach to the channels of the at least two opposing top sections of the reflector support apparatus.

9. The plant light reflection apparatus of claim 6, wherein the bottom major edge of the each piece of reflection material is attached to a linear frame member, and wherein the linear frame member is configured to lay on the surface of one or more plant growing mediums, or the uppermost edge of one or more plant containment devices of plants accepted by the central section.

10. The plant light reflection apparatus of claim 6, wherein the bottom major edge of the each piece of reflection material comprises a fold, and wherein the fold is configured to lay on the surface of one or more plant growing mediums, or the uppermost edge of one or more plant containment devices of plants accepted by the central section.

11. The reflector support apparatus of claim 6 further comprises opposing reflector nesting channels disposed between the at least two opposing top sections and the base of the central section of the reflector support apparatus, wherein the at least two opposing reflector panels further comprise flexible reflection material, and are configured to fully or partially nest inside the opposing reflector nesting channels.

12. The reflector support apparatus of claim 6 is a one piece extruded profile.

13. The plant light reflection apparatus of claim 6 comprises liquid drainage holes in the base of the central section of the reflector support apparatus.

14. A plant light reflector comprising:
a reflector panel configured to reflect light towards, and engage with one or more plants, the one or more plants each comprising one or more of a plant growing medium and a plant containment device, the reflector panel comprising:
an upper frame member;
a piece of reflection material comprising a top and bottom edge, wherein the top edge is attached to the upper frame member; and
one or more reflector support apparatuses attached to the upper frame member and configured to engage with, and be supported by the one or more plant growing mediums, or the one or more plant containment devices of the plants;
wherein after engagement with the one or more plants, the bottom edge of the piece of reflection material is configured to lay on the surface of the one or more plant growing mediums or the uppermost edge of the one or more plant containment devices of the plants, and the upper frame member is supported by the one or more reflector support apparatuses.

15. The reflector panel of claim 14 further comprises a lower frame member attached to the bottom edge of the piece of reflection material, wherein the bottom frame member is configured to lay on the surface of the one or more plant growing mediums or the uppermost edge of the one or more plant containment devices of the plants.

16. The reflector panel of claim 14 further comprises:
at least an upper frame member that further comprises four sides, and further comprises a channel comprising a first surface, a second surface that opposes the first surface, and an edge truss retention feature;
the reflection material comprises at least two long edges and a first surface, wherein at least one of the long edges is configured with at least one edge truss, wherein the at least one edge truss is configured from a corresponding fold in the reflection material that extends along all, or a portion of a corresponding long edge of the reflection material, wherein the at least one edge truss is configured at an angle relative to the first surface of the reflection material, and wherein the outermost edge of the at least one edge truss comprises an outer perimeter edge;
wherein the reflection material is configured for attachment to the at least an upper frame member such that the at least one edge truss of the reflection material nests inside a corresponding channel of the at least an upper frame member, and the perimeter edge of the at least one edge truss is engaged by the corresponding channel's edge truss retention feature such that the at least one edge truss becomes lodged and secured within a corresponding at least an upper frame member.

17. The one or more reflector support apparatuses of claim 14 are attached to the upper frame member with reflector support apparatus attachment devices that are configured to attach the garden stakes to the upper frame member, wherein the reflector support apparatus attachment devices may be slid along the upper frame member.

18. The plant light reflector of claim 14 comprises two plant light reflectors wherein the two reflector panels are facing each other, and wherein the profile thereof forms a relative U-shape.

19. The one or more reflector support apparatuses of claim 14 are collectively a stand with two reflector support apparatuses, wherein the stand is configured to support at least two upper and at least two lower frame members of two pieces of reflection material, and wherein the two lower frame members form a stem slot between them that allow plant stems shoots or trunks to protrude through.

20. The reflector support apparatuses of claim 14 are collectively a stand, wherein the stand is configured to support the upper and lower frame members and two or more pieces of reflection material in desired locations, and wherein the two lower frame members form a stem slot between them that allow plant stems shoots or trunks to protrude through, and wherein the stand further comprises one or more trellis net cross-bars or trellis net attachment features.
